(19) United States
(12) Patent Application Publication
(10) Pub. No.: US 2007/0283129 A1
(43) Pub. Date: Dec. 6, 2007

(54) Vector length tracking mechanism

(76) Inventors: Stephan Jourdan, Portland, OR (US); Avinash Sodani, Portland, OR (US); Michael Fetterman, Great Cambourne (GB); Per Hammarlund, Hillsboro, OR (US); Glenn Hinton, Portland, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/321,022

(22) Filed: Dec. 28, 2005

(51) Int. Cl. G06F 15/00

(52) U.S. Cl. 712/4; 712/E09.004

(57) ABSTRACT

According to one embodiment, a method is disclosed. The method includes receiving a value at a vector length (VL) tracker and establishing a VL for subsequent micro-operations (μops) that are to be executed corresponding to the value.

### FIELD OF THE INVENTION

The present invention relates to computer systems; more particularly, the present invention relates to central processing units (CPUs).

### BACKGROUND

Vector processors are designed to have a specific data width. Recently 256 bit (“b”) data width processors have been designed, replacing 128 b systems. In such processors, the execution data path may not match a maximum vector length (VL) (e.g., 256 b path for a maximum VL of 512 b). Instructions, such as vector streaming single instruction, multiple data extension (VSSE) instructions may be contain multiple micro-operations (μops), each able to operate on the full data path width. For instance, a VSSE instruction may decoded into two μops when fetched by a microprocessor, each μop being able to operate on 256 b of data.

However, all VSSE operations may not be performed on the full 512 b vector length. For example, various algorithms may be ported to VSSE-based code using a 128 b data length for compatibility and simplicity, which may cause the VSSE code to run slower than code using, for example, non-vector single streaming instruction, multiple data (SSE) instructions. In some applications, it may not be advantageous for VSSE code to run slower than corresponding SSE versions of the code.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates a block diagram of one embodiment of a CPU; and

FIG. 3 illustrates a block diagram of one embodiment of a fetch/decode unit.

### DETAILED DESCRIPTION

A vector length (VL) tracker in a CPU is described. In the following detailed description of embodiments of the invention, numerous specific details are set forth in order to provide a thorough understanding of embodiments of the present invention. However, it will be apparent to one skilled in the art that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs).

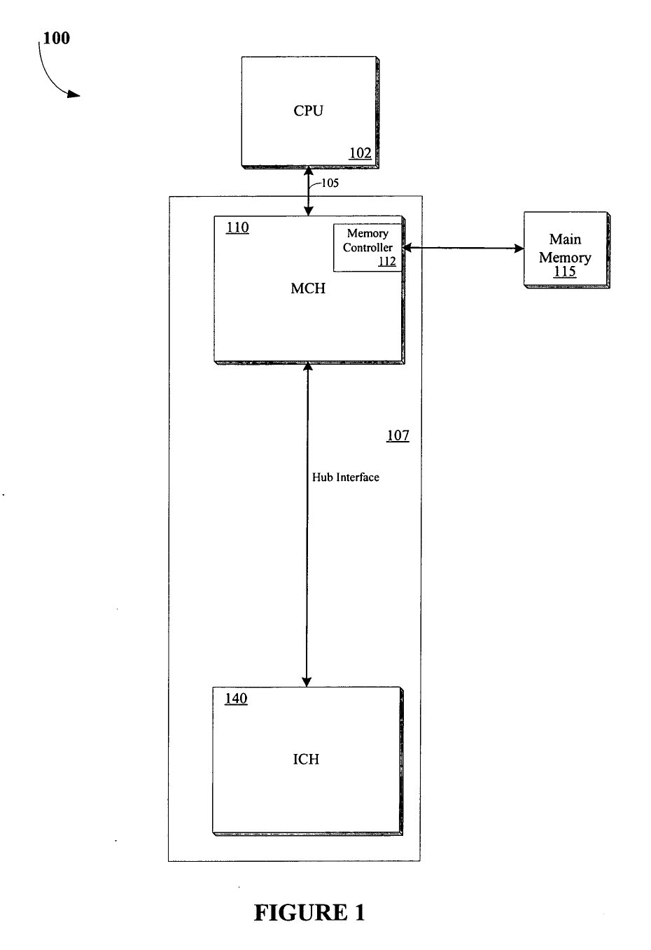

FIG. 1 is a block diagram of one embodiment of a computer system 100. Computer system 100 includes a central processing unit (CPU) 102 coupled to bus 105. A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100.

In one embodiment, main system memory 115 includes dynamic random access memory (DRAM); however, main system memory 115 may be implemented using other memory types. Additional devices may also be coupled to bus 105, such as multiple CPUs and/or multiple system memories. MCH 110 is coupled to an input/output control hub (ICH) 140 via a hub interface. ICH 140 provides an interface to input/output (I/O) devices within computer system 100.

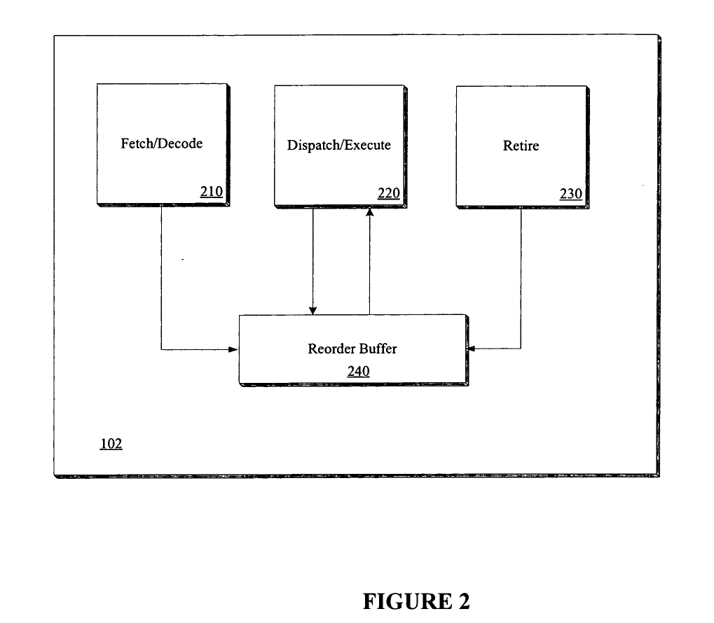

FIG. 2 illustrates a block diagram of one embodiment of CPU 102. CPU 102 includes fetch/decode unit 210, dispatch/execute unit 220, retire unit 230 and reorder buffer (ROB) 240. Fetch/decode unit 210 is an in-order unit that takes a user program instruction stream as input from an instruction cache (not shown) and decodes the stream into a series of micro-operations (μops) that represent the dataflow of that stream. In other embodiments, the fetch/decode unit 210 may be implemented in separate functional units or may include other functional units, such as a dispatching unit.

Dispatch/execute unit 220 is an out of order unit that accepts a dataflow stream, schedules execution of the uops subject to data dependencies and resource availability and temporarily stores the results of speculative executions. In other embodiments, the dispatch/execute unit 220 may be separate functional units, or include other functional units, such as a retire unit. Furthermore, in other embodiments, the dispatch/execute unit 220 may perform in-order operations in addition to or instead of out-of-order operations. Retire unit 230 is an in order unit that commits (retires) the temporary, speculative results to permanent states. In some embodiments, the retire unit 230 may be incorporated with other functional units.

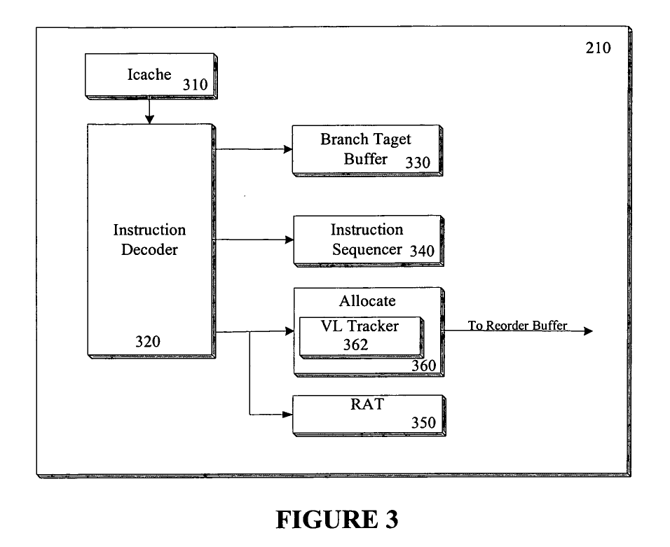

FIG. 3 illustrates a block diagram for one embodiment of fetch/decode unit 210. Fetch/decode unit 210 includes instruction cache (Icache) 310, instruction decoder 320, branch target buffer 330, instruction sequencer 340 and register alias table (RAT) 350. In one embodiment, Icache 310 is a local instruction cache that fetches cache lines of instructions based upon an index provided by branch target buffer 330.

In the embodiment illustrated in FIG. 3, instructions are presented to decoder 320, which decodes the instructions into μops. Some instructions are decoded into one to four μops using microcode provided by sequencer 340. Other instructions may be decoded into a different number of μops. The μops are queued and forwarded to RAT 350 where register references are converted to physical register references. The μops are subsequently transmitted to ROB 240. In addition, the μops are forwarded to allocator 360, which adds status information to the μops regarding associated operands and enters the μops into the instruction pool.

According to one embodiment, allocator 360 includes a vector length (VL) tracker 362 to track a VL value by determining a magnitude of the value, which may indicate the length of a vector (e.g., 256 b or lower, or higher than 256 b). In one embodiment, the VL value is used to set the vector length such that subsequent instructions will have a particular length corresponding to the value.

In another embodiment, setting a new VL value is performed via one or more μops that dynamically collect a new VL value by receiving the VL value from a register (e.g., VSSE arch register) during execution of the one or more μops. A μop that sets a VL value may be referred to as a “VL writer”. In yet another embodiment, a VL value may be determined from an immediate field within an instruction.

According to one embodiment, VL tracker 362 records whether the VL value is 256 b or lower, or higher than 256 b (e.g., greater than 32 b). If the VL value is 256 b or lower, a certain number corresponding μops may be generated, whereas if the VL value is more than 256 b, another number of corresponding uops may be generated. For example, in one embodiment, if the VL value is 256 b or lower, one μop is generated. Otherwise two μops are generated. In some embodiments, if the VL writer is allocated at allocator 360 with a static (or unchanging) value, VL tracker 362 determines the number of μops that will be generated.

In one embodiment, if the VL writer is allocated with a dynamic (or changing) value, tracker 362 goes into a pending state where tracker 362 predicts that the VL will be greater than 256 b. Consequently, a certain number of μops, such as two μops, are generated. After the VL writer is executed the new VL value is broadcasted to allocator 360 and tracker 362 goes into the corresponding state (greater than 32 B), where it continues to operate until a new VL value is received.

In one embodiment, μop execution may occur in a different order than the program order from which the corresponding instructions originated. In such an embodiment, VL values and corresponding state information may not be received by the allocator 360 until the VL writer is actually retired by the retirement unit. In another embodiment, multiple VL writers may exist concurrently within a processor's pipeline.

In such an embodiment, VL tracker 362 may track an identification indicator (ID) of the last allocated VL, causing an updated VL value to be stored in the VL tracker in response to the last VL writer being executed. In one embodiment, the VL tracker 362 updates the VL if the stored ID matches the ID of a particular VL writer that has been executed and whose corresponding VL value has been communicated to the VL tracker.

In some embodiments, VL tracker 362 may use the stored ID to handle branch mispredictions if, for example, the VL writer is in a branch that has been mispredicted. If the branch is mispredicted, tracker 362 determines if the remembered ID was available prior to the branch being generated (e.g., older). In one embodiment, if the ID is older, the VL value associated with the ID may be considered to be the correct value.

If the ID was available after the branch being generated (e.g., younger), the ID is discarded or otherwise not used. Once the ID is discarded, tracker 362 may return to the pending state described above, in which it may be presumed that VL will be greater than 256 b. Alternatively, tracker 362 may restore and use a previous VL value for subsequent VSSE tracking operations.

According to one embodiment, VL tracker 362 also handles narrow vectors where all of the bits of a destination register are higher in order than a vector length to be zeroed. For narrow vectors a problem may occur in which one μop may update the lower 256 b of the vector register, while the higher 256 b is not being affected. Therefore, if the VL value is changed back to 512 b and another vector μop is to read the full vector register, the validity of the higher bit values are uncertain since only the lower 256 b have been updated.

In one embodiment, VL tracker 362 maintains a zero bit for the higher 256 b to indicate that the higher 256 bits are to be read as zero following narrow vectors. In this embodiment, the zero bit is stored in RAT 350. Thus, for every VSSE arch register, a bit is added in RAT 350 to record whether the upper 256 are all zeroes. The bit is set whenever the VL tracker 362 state is greater than 32 B and cleared when in the opposite state.

Embodiments of the invention described above may improve performance of processing narrow vectors and may enable porting of software using SSE instructions to software using VSSE instructions that use the same vector length while maintaining substantially equivalent performance.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
receiving a vector length (VL) value; and
generating a first number of micro-operations (μops) if the VL value is equal to or less than a first value and generating a second number μops if the VL value is greater than the first value.

2. The method of claim 1 further comprising:
executing a VL writer μop; and
the VL tracker receiving the value from a register pointed to by the VL writer μop.

3. The method of claim 1 further comprising:
retiring a VL writer μop; and
the VL tracker receiving the value from a register pointed to by the VL writer μop

4. The method of claim 1 further comprising:
determining if the VL value is less than or equal to a predetermined value; and
establishing the VL for subsequent μops as a first length.

5. The method of claim 4 further comprising establishing the VL for subsequent μops as a second length if the VL value is greater than the predetermined value.

6. The method of claim 1 further comprising:
receiving a second value at the VL tracker; and
establishing a VL for subsequent μops that are to be executed corresponding to the second value.

7. The method of claim 6 wherein the first value has a first ID and the second value has a second ID.

8. The method of claim 7 further comprising the VL tracker updating the VL if a stored ID matches the second ID.

9. The method of claim 1 further comprising setting a bit in a register alias table (RAT) to indicate whether upper bits of a register are to be read as zeroes.

10. A computer system comprising:
a main memory device to store a first and second instruction, each of which to be decoded into at least one μop having a corresponding vector length (VL) value, and
a central processing unit (CPU) to fetch the first instruction and to retire a first number of uops in response to decoding the second instruction, wherein the first number of uops depends upon the VL value of the at least one μop corresponding to the first instruction.

11. The computer system of claim 10 wherein the CPU further comprises an execution unit to execute a VL writer μop and to broadcast the VL value to the VL tracker.

12. The computer system of claim 10 wherein the CPU further comprises a retire unit to retire a VL writer μop and to broadcast the VL value to the VL tracker.

13. The computer system of claim 10 wherein the VL tracker determines if the VL value is less than or equal to a predetermined value and establishes the VL for subsequent μops as a first length.

14. The computer system of claim 13 wherein the VL tracker establishes the VL for subsequent μops as a second length if the VL value is greater than the predetermined value.

15. The computer system of claim 10 further wherein the VL tracker compares a stored ID to an ID associated with the value and establishes the VL if the stored ID matches the ID associated with the value.

16. A central processing unit (CPU) comprising:
an execution unit to execute a VL writer μop to set a VL value;
a vector length (VL) tracker to cause a first number of μops to be generated if the VL value is within a first range of values and to cause a second number of μops to be generated if the VL value is within a second range of values.

17. The CPU of claim 16 wherein the VL tracker determines if the VL value is less than or equal to a predetermined value and establishes the VL for subsequent μops as a first length.

18. The CPU of claim 17 wherein the VL tracker establishes the VL for subsequent μops as a second length if the VL value is greater than the predetermined value.

19. The CPU of claim 16 further wherein the VL tracker compares a stored ID to an ID associated with the value and establishes the VL if the stored ID matches the ID associated with the value.

20. The CPU of claim 16 further comprising a register alias table (RAT) setting, wherein the VL tracker sets bit in a to indicate whether upper bits of a register are to be read as zeroes.

21. The CPU of claim 16 wherein the execution unit broadcasts the VL value to the VL tracker.

22. The CPU of claim 16 wherein the CPU further comprises a retire unit to retire a VL writer μop and to broadcast the VL value to the VL tracker.

23. An article of manufacture including one or more computer readable media that embody a program of instructions, wherein the program of instructions, when executed by a processing unit, causes the processing unit to perform the process of:
receiving a vector length (VL) value; and
generating a first number of micro-operations (μops) if the VL value is equal to or less than a first value and generating a second number μops if the VL value is greater than the first value.

24. The article of manufacture of claim 23 wherein the program of instructions, when executed by a processing unit, further causes the processing unit to perform the process of:
executing a VL writer μop; and
the VL tracker receiving the value from a register pointed to by the VL writer μop.

25. The article of manufacture of claim 23 wherein the program of instructions, when executed by a processing unit, further causes the processing unit to perform the process of:
retiring a VL writer μop; and
the VL tracker receiving the value from a register pointed to by the VL writer μop

26. The article of manufacture of claim 23 wherein the program of instructions, when executed by a processing unit, further causes the processing unit to perform the process of:
determining if the VL value is less than or equal to a predetermined value; and
establishing the VL for subsequent μops as a first length.

27. The article of manufacture of claim 26 wherein the program of instructions, when executed by a processing unit, further causes the processing unit to perform the process of establishing the VL for subsequent μops as a second length if the VL value is greater than the predetermined value.

28. The article of manufacture of claim 23 wherein the program of instructions, when executed by a processing unit, further causes the processing unit to perform the process of:
receiving a second value at the VL tracker; and
establishing a VL for subsequent μops that are to be executed corresponding to the second value.

29. The article of manufacture of claim 28 wherein the first value has a first ID and the second value has a second ID, wherein the VL tracker updates the VL if a stored ID matches the second ID.

30. The article of manufacture of claim 23 wherein the program of instructions, when executed by a processing unit, further causes the processing unit to perform the process of setting a bit in a register alias table (RAT) to indicate whether upper bits of a register are to be read as zeroes.
